(19) United States
(12) Patent Application Publication
(10) Pub. No.: US 2009/0179855 A1
(43) Pub. Date: Jul. 16, 2009

(54) Multifunctional Operating Device and Method

(75) Inventors: Frank Bilz, Muenchen (DE); Tom Willmann, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/360,495

(22) Filed: Jan. 27, 2009

Related U.S. Application Data
(63) Continuation of application No. PCT/EP2007/006031, filed on Jul. 7, 2007.

(30) Foreign Application Priority Data
Jul. 28, 2006 (DE) 10 2006 034 971.7

(51) Int. Cl. G09G 5/00

(52) U.S. Cl. 345/156; 715/810

(57) ABSTRACT

A multifunctional operating device is provided that includes a display unit, at least one operating element, to which a function can be assigned within a menu structure and can be selected when the respective operating element is actuated, and associated visual information on the function selected by the operating element. The visual information is displayed on the screen during at least one operating status of the operating element. The time during which the associated visual information is displayed depends on at least one display parameter which can be varied by way of an adjusting intervention.

### CROSS-REFERENCE TO RELATED APPLICATIONS

This application is a continuation of PCT International Application No. PCT/EP2007/006031, filed on Jul. 7, 2007, which claims priority under 35 U.S.C. § 119 to German Application No. 10 2006 034 971.7, filed Jul. 28, 2006, the entire disclosures of which are expressly incorporated by reference herein.

### BACKGROUND AND SUMMARY OF THE INVENTION

The invention relates to a multifunctional operating device, and method of using same, having a display unit. At least one operating element is provided to which a function can be assigned within a menu structure and can be selected when the respective operating element is operated. Assigned visual information concerning the function selected by the operating element is displayed on the video screen in the case of at least one operating status of the operating element.

An operating device of this type is known from German patent document DE 102004058954 A1 (having U.S. counterpart publication 2007/0242050 A1). However, the operating device described in DE 102004058954A1 does not take into account all possible preferences of the concerned user of the operating device. For example, experienced users of such an operating device may have the desire optionally to do without the display of corresponding visual information.

It is an object of the invention to provide an operating device where the preferences of individual users are taken into account in an improved manner.

This object is achieved by providing a multifunctional operating device and method having a display unit, at least one operating element to which a function can be assigned within the menu structure and can be selected when the respective operating element is operated, and assigned visual information concerning the function selected by the operating element, which is displayed on the video screen in the case of at least one operating status of the operating element, wherein the duration of the display of the assigned visual information depends on at least one display parameter which can be varied by an adjusting intervention. Advantageous embodiments and further developments of the invention are described herein.

The invention provides that the duration of the display of the visual information, which is assigned to the operating element, depends on at least one display parameter that can be varied by an adjusting intervention. As a result, the various preferences, knowledge and operating habits of many different users are taken into account.

The invention is based on the idea that an adjustment of the duration of the display of the assigned visual information represents a possibility of taking into account the preferences of individual operators, which possibility can very easily be technically implemented but is highly effective. Particularly the fact that, as a rule, the experience with the operating device is very different in the case of different users can be taken into account in this manner.

An experienced and/or rapidly reacting user would, for example, prefer a short display duration, whereby an “image interference” (for example, the overlapping of other video screen contents), which is the result of the display of the visual information, can be kept relatively low. Many users require only a very brief time period, for example, for perceiving a graphic symbol, for example, representing the assigned visual information.

In contrast, a less experienced user would probably prefer sufficient time for attentively reading a HELP text which may, for example, represent the assigned visual information.

The paradigm of the adjustment of the duration of the display of the assigned visual information is particularly advantageous because the respectively conceivable extreme cases cause a basic change of the quality of the operating device. Thus, on the one hand, an adjustment of the “zero” duration causes a complete elimination of the display. On the other hand, the extreme “infinite” case causes a lasting visual output which does not disappear after a certain time.

In this respect, by varying the display parameter according to the invention, preferably an omission of the display can be set. A particularly experienced user is therefore not “bothered” by the appearance of undesired information. The setting of the omission can particularly take place in that a disappearing duration of the display is set.

According to a preferred embodiment of the invention to be provided as an alternative or in addition, by varying the display parameter according to the invention, a display can be set that does not disappear as a function of time. A particularly careful or inexperienced operator therefore has no time limitation when viewing the visual information. The corresponding adjustment can take place particularly in that a very long duration of the display is set.

By means of the variation of a single parameter according to the invention, preferably three different operating qualities can be set:

No display of the visual information (when a very short display duration, particularly a “zero” display duration is set);

a lasting display (when a very long display duration, particularly an “infinite” display duration is set);

after a predefined time, the display of the visual information disappears (when a corresponding finite display duration is set).

In this case, it is remarkable that the user can cause a qualitative change of the operating action of the operating device in that he carries out a quantitative variation of one parameter.

Since only a single parameter has to be changed, the required adjusting intervention can, on the one hand, be designed to be particularly simple for the operator. On the other hand, the adjustability can be ensured in a technically easy fashion. It can, for example, also easily be embedded in a menu-based operating structure because only a single menu item is required.

The invention is particularly suitable for a multifunctional operating device in a motor vehicle.

The adjusting intervention is preferably such that it can be carried out independently by an average vehicle user.

The adjusting intervention can preferably take place by an operating element arranged in the vehicle interior. The operating element used in this case can be assigned to the multifunctional operating device itself. In particular, in the case of a multifunctional operating device with a menu-based operating structure, which can be operated by way of at least one rotary/push actuator, such a rotary/push actuator can be used in order to adjust the display parameter under a certain menu item provided for this purpose.

The possibility of the adjustment by the driver or another vehicle occupant from the vehicle interior is advantageous particularly because, as a rule, a successful “trial and error” method can only be carried out in this manner; i.e. according to the invention, the operator adjusts the duration of the display and, in the subsequent operating steps, pays attention to whether or how he can handle the changed adjustment. Corresponding to his observations, he will then, if necessary, make another adjustment of the display parameter until he has found an adjustment that best suits him.

If a variation of the basic operating quality by the adjustment of extreme values of the display parameter is made possible, it may be advantageous for the user to have to exceed a haptic threshold and/or to feel a “catching” for adjusting such an extreme value. Other haptic effects (for example, a vibration) may also be used correspondingly. In addition or as an alternative, visual effects (for example, color changes of an adjusting bar) and/or acoustic effects, (for example, clicking) are also contemplated for stressing that such an extreme value has been reached.

In addition to the preferred adjustability from the vehicle interior, alternative types and methods of adjustment (for example, configuration of the vehicle at a home PC and transfer of the configuration data into the vehicle, for example, by way of keys) are also contemplated and can be technically implemented. They may also be provided in addition to an adjustment from the vehicle interior.

The present invention predominantly relates to the adjustment of the duration of the display of visual information. In this case, the triggering of the display of the information as well as the determination of the point-in-time at which the display of the information begins can be carried out in many different fashions. Numerous variations are known for this purpose from the state of the art. On the one hand, a separate operating element (“HELP key”) or a certain menu item of a menu-based operating structure (“HELP function”) can be provided for triggering the display of the visual information. However, the display of the visual information it preferably triggered in the manner and fashions known from German patent document DE 102004058954 A1, particularly by approaching or touching the respective operating element.

The assigned visual information in the sense of the invention can be shaped in many variations. A large number of variations are known from the state of the art. The visual information may, for example, completely or predominantly cover the surface area of the display unit. As an alternative, the visual information may utilize only a part of the display surface, for example, in that a window opens up on the display unit or a bar (compare the Windows Taskbar) becomes visible.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a view of a video screen display during the adjustment of a display parameter according to a preferred embodiment of the present invention.

### DETAILED DESCRIPTION OF THE DRAWINGS

A multifunctional operating device can be operated by way of a rotary/push actuator. The functions that can be operated by way of the multifunctional operating device are organized in a menu-based operating structure. In addition, the multifunctional operating device includes a display unit having a display screen.

The multifunctional operating unit also includes abbreviated-selection keys by which certain functions can be called directly.

The abbreviated-selection keys can be freely allocated but are not labeled. To learn the current key allocation, a user may only lightly place his finger on such an abbreviated-selection key instead of pressing the latter. As the placing is detected by corresponding sensing devices, a HELP window, i.e. assigned visual information in the sense of the invention, is immediately displayed on the video screen. The current function of the key is described in detail in the HELP window. Depending on the function, different types of information are available for this purpose. Some functions are only described by a text; others graphically or by symbols; and others are described by graphic animation or a film sequence. As an alternative, a voice output would also be possible.

Beginning with the touching of the respective abbreviated selection key, the HELP window is displayed for only a certain time period. This time period is defined by a display parameter.

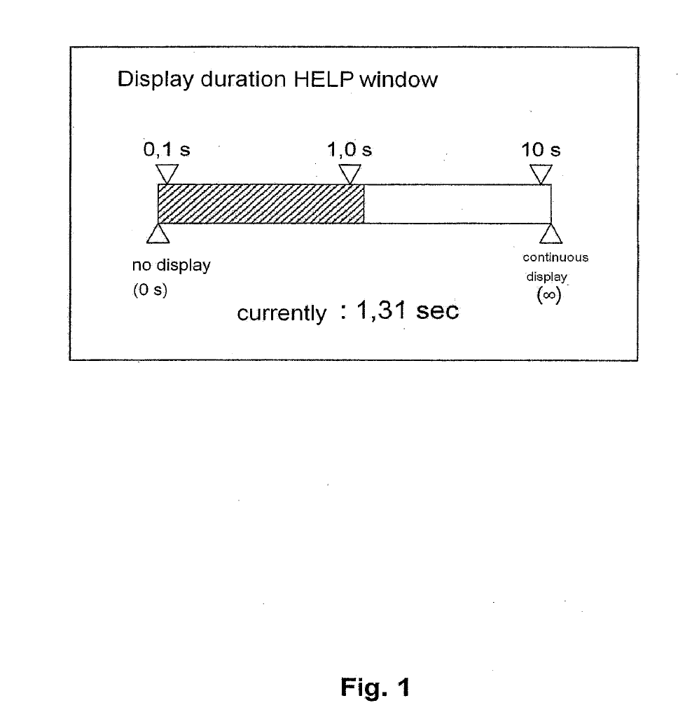

This display parameter, in turn, can be adjusted by the multifunctional operating device. For this purpose, the user can navigate to a “Display Duration HELP Window” menu item. The video screen view of FIG. 1 appears. The user can now set the corresponding display duration by operating the rotary/push actuator in a customary manner, i.e., setting of the value by rotating the actuator; confirmation by pushing actuator.

When the user sets a display duration of more than 0.1 seconds and less than 10 seconds, in the subsequent time, any displayed HELP window is automatically terminated after the corresponding display duration.

When a display duration of 0 seconds is set, no HELP window is displayed in the following period. In the present example of FIG. 1, the adjusting bar is therefore provided with the final “no display” label in addition to the final “0 s” label.

When the display duration ∞ (“infinite”) is set, HELP windows are displayed in the time that follows until another touching of the abbreviated selection key takes place or an abbreviated-selection key is actuated such that its function is requested. Other termination criteria for the display of the HELP window are also contemplated, but no purely time-based termination takes place anymore. Corresponding to the resulting operating quality, in the present example, the adjusting bar is provided with the final “continuous display” label in addition to the final “∞” label.

The user should exceed a haptic threshold and, therefore, feel a catching when he sets one of the end settings “no display” or “continuous display” by rotating the rotary/push actuator.

Embodiments which do not explicitly mention the extreme values “0” and “∞”, but cause a comparable effect by way of the adjusting of a single parameter, are equivalent to the above-described preferred embodiment of the invention.

If, according to the above-described further developments of the invention, the possibility is provided for setting the display duration to the “zero” or “infinite” values, the correspondingly resulting action of the operating device, with respect to the software, does not necessarily have to be implemented only by utilizing the display parameter adjusted according to the invention (although this is a conceivable variant of the implementation). Likewise, as an alternative or in addition, however, a binary software condition provided specifically for this purpose can take the corresponding setting into account (for example, the setting of a Boolean variable SHOW_HELPWINDOW to the FALSE value if the display duration on the video screen is set to zero by means of the rotary/push button). The deciding advantage of such further developments of the invention, from the user's viewpoint, is the conclusive operating philosophy of quantitatively adjusting a parameter and, as a result, nevertheless, being able to cause qualitative differences of the operating action.

The foregoing disclosure has been set forth merely to illustrate one or more embodiments of the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A multifunctional operating device, comprising:
a display unit having a display screen;
at least one operating element operatively coupled with the display unit, a function within a menu structure being assignable to the operating element and being selectable via actuation of the operating element;
associated visual information concerning the function selectable by the operating element, the assigned visual information being displayed on the screen during at least one operating state of the operating element; and
wherein a time period during which the assigned visual information is displayed depends on at least one display parameter which is variable by way of an adjusting intervention.

2. The multifunctional operating device according to claim 1, wherein an omission of the assigned visual information from the screen is settable by varying the display parameter.

3. The multifunctional operating device according to claim 2, wherein the omission is settable by setting a disappearing duration of the assigned visual information from the screen.

4. The multifunctional operating device according to claim 1, wherein a display of the assigned visual information is settable that does not disappear as a function of time by varying the display parameter.

5. The multifunctional operating device according to claim 4, wherein the display that does not disappear as a function of time is adjusted by setting a very long duration of the display.

6. The multifunctional operating device according to claim 3, wherein a display of the assigned visual information is settable that does not disappear as a function of time by varying the display parameter.

7. The multifunctional operating device according to claim 6, wherein the display that does not disappear as a function of time is adjusted by setting a very long duration of the display.

8. The multifunctional operating device according to claim 1, wherein the adjusting intervention is performed via the operating element arranged in an interior of the vehicle.

9. The multifunctional operating device according to claim 8, wherein the operating element for performing the adjusting intervention is associated with the multifunctional operating device.

10. A method of operating a multifunctional operating device having a display operatively coupled with an operating element, a function within a menu structure being assignable to, and selectable by, the operating element, the method comprising the acts of:
assigning visual information concerning a function selectable by the operating element;
controlling a time period during which the assigned visual information is displayed based on at least one display parameter; and
adjusting the at least one display parameter to vary the time period during which the assigned visual information is displayed.

11. The method according to claim 10, further comprising the act of adjusting the display parameter to omit a display of the assigned visual information.

12. The method according to claim 10, further comprising the act of adjusting the display parameter to provide a long-lasting display of the assigned visual information.

13. The method according to claim 11, wherein the act of adjusting the display parameter is performed via an operating element arranged in an interior of a motor vehicle.

14. The method according to claim 12, wherein the act of varying the display parameter is performed via an operating element arranged in an interior of a motor vehicle.
